(19) United States
(12) Patent Application Publication
(10) Pub. No.: US 2022/0210624 A1
(43) Pub. Date: Jun. 30, 2022

(54) SERVICE BASED ARCHITECTURE MANAGEMENT

(71) Applicant: NOKIA TECHNOLOGIES OY, Espoo (FI)

(72) Inventors: Jing PING, Chengdu (CN); Anatoly ANDRIANOV, Schaumburg, IL (US); Olaf POLLAKOWSKI, Berlin (DE)

(73) Assignee: NOKIA TECHNOLOGIES OY, Espoo (FI)

(21) Appl. No.: 17/429,680

(22) PCT Filed: Feb. 13, 2019
(86) PCT No.: PCT/CN2019/074990

§ 371 Date: Aug. 10, 2021

(51) Int. Cl. H04W 4/50; H04W 4/12; H04W 24/04

(52) U.S. Cl. CPC H04W 4/50; H04W 24/04; H04W 4/12

(57) ABSTRACT

Embodiments of the present disclosure relate to service based architecture management. A method of service based architecture management comprises creating, at a management entity, a managed service instance for managing a service associated with a service provider, the managed service instance including a set of attributes associated with the service at least including a state of the managed service instance; transmitting the set of attributes to the service provider, to enable the service provider to activate the service based on the set of attributes; receiving, from the service provider, a service activating message indicating that the service is activated; and updating the state of the managed service instance based on the service activating message. In this way, the network management can be implemented in a NF Service level.

### FIELD

Embodiments of the present disclosure generally relate to the field of telecommunication and in particular, to the service based architecture management.

### BACKGROUND

The 5G Core (5GC) Service Based Architecture (SBA) introduced by Third Generation Partnership Project Services and System Aspects Work Group 2 (3GPP SA2), where Network Function (NF) Service concept represents one type of capability exposed by an NF Service Producer to other authorized NF Service Consumer through a service-based interface. A NF may expose one or more NF services. Each NF service shall be accessible by means of an interface. An interface may consist of one or several operations. To be discovered and consumed by other control plane NFs, a NF Service instance need to be registered to Network Repository Function (NRF). Each of the NF services offered by a Network Function shall be self-contained, reusable and use management schemes independently of other NF services offered by the same Network Function (e.g. for scaling, healing, etc.)”. In addition, Operation and Management (OAM) system should support NF service instances registration, deregistration, update, etc., on Network Repository Function (NRF) triggered by NF or NF service instance lifecycle event.

The existing Third Generation Partnership Project Services and System Aspects Work Group 5 (3GPP SA5) can only support lifecycle and fault, configuration, accounting, performance, security (FCAPS) management of subnetwork and Network Functions.

### SUMMARY

In general, example embodiments of the present disclosure provide a solution for service based architecture management.

In a first aspect, there is provided a method for service based architecture management. The method comprises creating, at a management entity, a managed service instance for managing a service associated with a service provider, the managed service instance including a set of attributes associated with the service at least including a state of the managed service instance, transmitting the set of attributes to the service provider, to enable the service provider to activate the service based on the set of attributes; receiving, from the service provider, a service activating message indicating that the service is activated; and updating the state of the managed service instance based on the service activating message.

In a second aspect, there is provided an apparatus for service based architecture management. The apparatus comprises at least one processor; and at least one memory including computer program codes; the at least one memory and the computer program codes are configured to, with the at least one processor, cause the apparatus at least to create, at a management entity, a managed service instance for managing a service associated with a service provider, the managed service instance including a set of attributes associated with the service at least including a state of the managed service instance; transmit the set of attributes to the service provider, to enable the service provider to activate the service based on the set of attributes; receive, from the service provider, a service activating message indicating that the service is activated; and update the state of the managed service instance based on the service activating message.

In a third aspect, there is provided an apparatus comprising means to perform the steps of the method according to the first aspect. The apparatus comprises means for creating, at a management entity, a managed service instance for managing a service associated with a service provider and accessed by a service consumer, the managed service instance including a set of attributes associated with the service at least including a state of the managed service instance; means for transmitting the set of attributes to the service provider, to enable the service provider to activate the service based on the set of attributes; means for receiving, from the service provider, a service activating message indicating that the service is activated; and means for updating the state of the managed service instance based on the service activating message.

In a fourth aspect, there is provided a computer readable medium having instructions stored thereon. The instructions, when executed on at least one processor of a device, cause the device to carry out the method according to the first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 shows an architecture 100 in which example embodiments of the present disclosure can be implemented;

FIG. 2 shows a diagram of an example process 200 of service based architecture management according to some example embodiments of the present disclosure;

FIG. 3 shows a diagram of an example process 300 of service based architecture management according to some example embodiments of the present disclosure;

FIG. 4 shows a diagram of an example process 400 of service based architecture management according to some example embodiments of the present disclosure;

FIG. 5 shows a diagram of an example process 500 of service based architecture management according to some example embodiments of the present disclosure;

FIG. 6 shows a diagram of service based architecture management according to some example embodiments of the present disclosure;

FIG. 7 shows a diagram of service based architecture management reception according to some example embodiments of the present disclosure;

FIG. 8 shows a flowchart of an example method 800 of the discontinuous reception for the terminal device according to some example embodiments of the present disclosure;

FIG. 9 is a simplified block diagram of a device that is suitable for implementing example embodiments of the present disclosure; and

FIG. 10 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

As used in this application, the term “circuitry” may refer to one or more or all of the following:

(a) hardware-only circuit implementations (such as implementations in only analog and/or digital circuitry) and

(b) combinations of hardware circuits and software, such as (as applicable):

(i) a combination of analog and/or digital hardware circuit(s) with software/firmware and

(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “network” refers to a network following any suitable wireless communication standards, such as New Radio (NR), Long Term Evolution (LTE), LTE-Advanced (LTE-A), Wideband Code Division Multiple Access (WCDMA), High-Speed Packet Access (HSPA), and so on. The “network” may also be referred to as a “wireless communication system.” Furthermore, communications between network devices, between a network device and a terminal device, or between terminal devices in the network may be performed according to any suitable communication protocol, including, but not limited to, Global System for Mobile Communications (GSM), Universal Mobile Telecommunications System (UMTS), Long Term Evolution (LTE), New Radio (NR), European Telecommunications Standards Institute (ETSI), wireless local area network (WLAN) standards, such as the IEEE 802.11 standards, and/or any other appropriate wireless communication standard either currently known or to be developed in the future.

As used herein, the term “management entity” refers to any component, module or node in a network management side, which may be referred to as a Management Function, an Element Manager, a Network Manager or a Domain Manager defined in 3GPP SA5. The management entity may define a managed service Information Object Class (Managed Service IOC) and build the association between the Managed Service IOC and a Network Function (NF) service in the network side. As an option, the term “management entity” may be also referred to a module embedded in the network side which may manage the service of the network.

As used herein, the term “service registration function” may be considered as a network entity for producing a registration service to be used for registering the service, discovering the service or deregistering the service. For example, a service registration function may be referred to as Network Repository Function (NRF) in 5G Core system as a NF Service repository function. As an option, the term “service registration function” may be also referred to a management entity which used for management service registration.

As used herein, the term “service provider” may be considered as a network entity for producing a service to be accessed by service consumer. For example, a service provider may be referred to as Authentication Server Function (AUSF) defined in 5G Core Network Function which produces the terminal device (for example, a user equipment (UE)) authentication Service to be accessed by the (Access and Mobility Management function) AMF.

As used herein, the term “service consumer” may be considered as a network entity for consuming a service to complete a traffic flow. For example, a service consumer may be referred to as AMF defined in 5G Core Network Function which can access the terminal device (for example, a user equipment (UE)) authentication service provided by AMF during the terminal device registration.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

In the conventional approach, a Network Function (NF) may expose one or more NF services (NfS). Each NfS shall be accessible by means of an interface. In this case, the current management specifications can only support lifecycle and fault, configuration, accounting, performance, security (FCAPS) management of subnetwork and NFs. The management for the NfS level granularity has not been considered. For the service based network architecture, it is expected that the network management for a NfS level could be achieved.

For example, the expected network management for a NfS level may comprise the following operations:
The alarms (i.e., fault notifications) is expected per NfS rather than per NF;
The measurement of the performance parameters is expected per NfS, including the message count per NfS, the number of active sessions per NfS, the number of connected peers per NfS, CPU/memory utilization per NfS, etc., rather than per NF;
The configuration changes are expected to be applied for NfS rather than per NF. For example, a same configuration attribute may have different value for different NfS of the same NF;
Certain NfS is expected to be allowed to be either inactive or even not present in a particular instance of NF. For example, for a NF of type “NF-A” with 3 defined NfSs “NfS-A”, “NfS-B”, “NfS-C”, it may be possible to have a NF instance NF-A1 with only [NfS-A, NfS-B], while NF instance NF-A2 with all 3 NfSs [NfS-A, NfS-B, NfS-C];
More than one instance of NfS (of a particular defined type) in the same instance of NF is expected to be allowed. For example, considering the NF of type “NF-A” with 3 defined NfSs “NfS-A”, “NfS-B”, “NfS-C”, it may be possible to have a NF instance NF-A1 with more than one instance of NfS-A as [NfS-A1, NfS-A2, NfS-A3, NfS-B1, NfS-C1];
It is expected that if an instance of NfS is scaled, other NfSs of this NF are not equally scaled.
For Network Slicing scenarios, the granularity of NF participation in a Network Slice could be on NfS level. For example, it may be possible that certain NfS of a NF participates only in a particular instance of a Network Slice, but not in all instances where NF instance participates. For example, for a NF of type “NF-A” with 3 defined NfSs “NfS-A”, “NfS-B”, “NfS-C” and participating in two instances of Network Slice [Slice-1, Slice-2], it may be possible to have a NF instance where the associations between the Slices and NfS would be: [Slice-1: [NfS-A1, NfS-C1]], [Slice-2: [NfS-A1, NfS-B1]].
For Network Slicing scenarios, for an instance of NF participating in multiple Network Slices, it may be possible that NfS of the same type participate only in a particular instance (or group of instances) of a Network Slice. For example, for a NF instance NF-A1 with more than one instance of NfS-A as [NfS-A1, NfS-A2, NfS-A3, NfS-B1, NfS-C1] and participating in four instances of Network Slice [Slice-1, Slice-2, Slice-3, Slice-4], the associations between the Slices and NfS would be: [Slice-1: [NfS-A1, NfS-B1, NfS-C1]], [Slice-2: [NfS-A2, NfS-B1, NfS-C1]], [Slice-3: [NfS-A3, NfS-B1, NfS-C1]], [Slice-4: [NfS-A3, NfS-B1, NfS-C1]].

Therefore, the present disclosure proposes an approach of a service based architecture management by creating a managed service instance at a management entity and building the association between the managed service instance and the service, to independently manage the NfS, so that the network management for the NfS level could be achieved.

The service based architecture management mechanism of the present disclosure introduces abstract Service Information Object Class (IOC) in a Federated Network Information Model (FNIM).

The service based architecture management mechanism of the present disclosure also introduces Managed Service IOC in 3GPP SA5 generic Network Resource Model (NRM) which is inherited from Service_IOC defined in FNIM. As used herein, the term “managed service instance” refers to an object created at management entity which is associated with a real service deployed or will be deployed in the network.

The management of the mechanism proposed in embodiments of the present disclosure allows management system to manage the lifecycle, performance, alarm, state at service level, and share resources between network slices in service level, as well as assist registration of a service to the Service Registration Function (for example, NRF defined in 3GPP SA2).

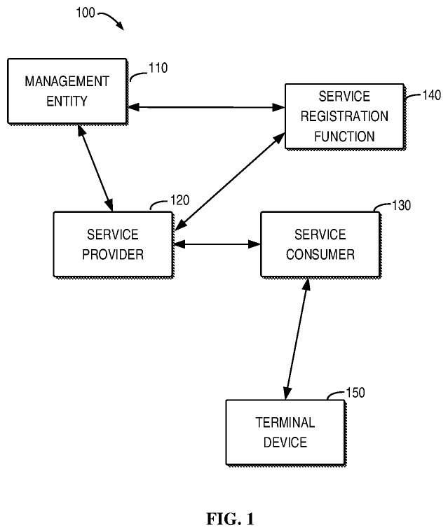

FIG. 1 shows an example architecture 100 in which example embodiments of the present disclosure can be implemented. The example architecture 100 may comprise a management entity 110 which is provided at the network management side and may be considered as any entity or module of the network management system, or embedded in a network function. In some embodiments, the management system may also be considered as a management entity.

The example architecture 100 may further comprise a service provider 120, which may produce the corresponding services based on the requirement of the network management system or the requirement of the user. The service provided by the service provider may be accessed by the service consumer 130, through which a terminal device 150 (for example, a UE) may use the service.

The management entity 110, on which the management function may be implanted, may manage the network function. Currently, based on the management specification, the management entity 110 may not directly manage services independently. For example, the management entity 110 may not scale a service independently of the network function.

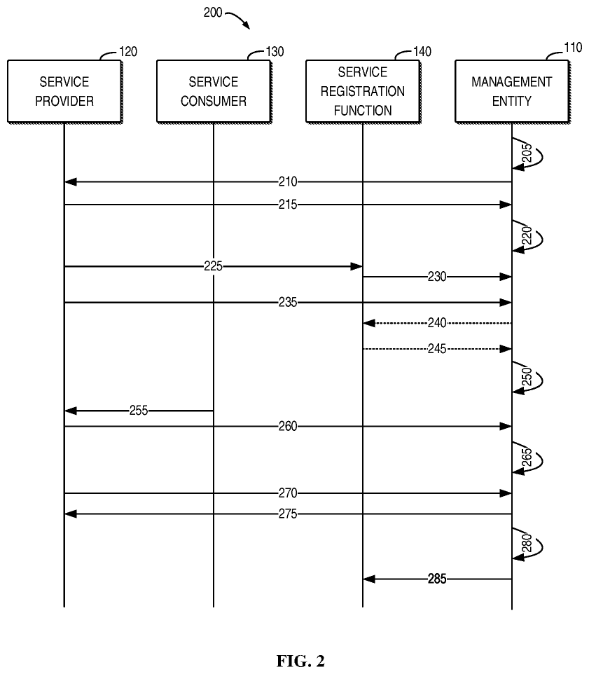

Principle and implementations of the present disclosure will be described in detail below with reference to FIG. 2-8. FIG. 2 shows a process 200 according to example embodiments of the present disclosure. For the purpose of discussion, the process 200 will be described with reference to FIG. 1. The process 200 may involve a service based architecture management.

As shown in FIG. 2, the management entity 110 creates 205 a managed service instance for managing a service to be provided from a service provider 120 to a service consumer 130. The trigger condition for creating the managed service instance may be various. In some embodiments, if a service is request by the user, the management entity 110 may create a managed service instance associated with this service. In some embodiments, if the service is generated by the service provider 120, the management entity 110 may create a managed service instance associated with this service. That is, the managed service instance may be created after or before the generation of the service.

If the managed service instance is creating, some attributes of the service are defined for the managed service instance by the management entity 110. The attributes associated with the service may include the state of the managed service instance and registration state of the managed service instance. The state of the managed service instance may include an operational state, a usage state and an administrative state. Besides the state, the attributes associated with the service may further include an attribute associated with lifecycle management; an attribute associated with configuration management; an attribute associated with performance management; an attribute associated with fault management; an attribute associated with trace management; an attribute associated with software management; an attribute associated with account management; and an attribute associated with security management.

In the phase of service deployment, the state of the managed service instance is “Locked/Disabled/Idle” (Administrative State/Operational State/Usage State). The registering state of the managed service instance is “Deregistered”. The deployment and configuration related attributes of the service are stored in managed service instance. A performance management instance is created and associated to the managed service instance. A fault management instance is created and associated to the managed service instance.

The management entity 110 transmits 210 the set of attributes to the service provider 120. The attributes, in particular the administrative state defined the managed service instance may cause the service to be unlocked. Thus, the management entity 110 may deploy, configure and unlock the service based on deployment and configuration related attributes passed from the management entity 110.

Further, the management entity 110 receives 215 service activating message from the service provider 120. The service activating message may indicate that the service is activated. After receiving the response from the service provider 120, the management entity 110 updates 220 the state of the managed service instance based on the service activating message.

In some embodiments, if the service has been activated, the state of the managed service instance may be set as “Unlocked/Enabled/Idle” (Administrative State/Operational State/Usage State).

Before the service is accessed by the service consumer 130, the service should be registered. The service provider 120 could initiate the registering process. Alternatively, the management entity 110 may also initiate the registering process.

In a case that the registering process is initiated by the service provider 120, the service provider 120 may transmit 225 the registering request to a service registration function 140, at which the service could be registered or deregistered. After the service is successfully registered, as an option, the service provider 120 may inform 235 the management entity 110 that the service has been registered. As another option, the service registration function 140 may inform 230 the management entity 110 that the service has been registered. The action 230 can be existing attribute change notification defined already in 3GPP SA5 if the Service Registration Function is in the same management domain of the Service Provider, or the action 230 could be a new defined interface for registering notification. After the management entity 110 receives a message indicating that the service has been registered, the management entity 110 may update 250 the registering state of the managed service instance. That is, the registering state is changed from “Deregistered” to “Registered”.

In a case that the registering process is initiated by the management entity 110, the management entity 110 may transmit 240 the registering request to a service registration function 140. The action 240 can be existing attribute provisioning service defined already in 3GPP SA5 if the Service Registration Function is in the same management domain of the Service Provider, or the action 240 could be a new defined interface for registering request. If the management entity 110 receives 245 a message indicating that the service has been registered, the management entity 110 may update 250 the registering state of the managed service instance. The registering state is changed from “Deregistered” to “Registered”.

After the service has been registered, the service consumer 130 may access 255 the service of the service provider 120. If the service is accessed by the service consumer 130, the service provider 120 may update the usage status of the service and transmit 260 the report of the the usage status to the management entity 110.

In some embodiments, the usage status of the service can be part of performance data which can be initiated to send by service provider 120 or requested by the management entity 110.

If the service is accessed by the service consumer 130 and a message is received from the service provider 120 indicating that the service has been accessed, the management entity 110 may update 265 the state of the managed service instance, again.

In some embodiments, if the service has been accessed, the state of the managed service instance may be set as “Unlocked/Enabled/Active” (Administrative State/Operational State/Usage State).

The management entity 110 may configure performance control parameters on the service provider 120 based on the performance management instance associated to the managed service instance and collects performance data of the service according to performance control parameters.

The management entity 110 may configure fault control parameters on the service provider 120 based on the fault management instance associated to the managed service instance and collects alarm/event of the service of the service according to fault control parameters.

It should be understood that the service provider 120 may inform the performance data or alarm/event of the service to the management entity 110. Alternatively, the management entity 110 may request the performance data or alarm/event of the service from the service provider 120.

If the service has been deployed, the service provider 120 may transmit 270 the status data, such as the performance data or alarm/event of the service, to the management entity 110. After analyzed the status data, if the performance of service is getting worse or the alarm is notified, the management entity 110 may perform the attribute reconfiguration to optimize the performance of service.

For example, the management entity 110 may transmit 275 a set of new attributes to the service provider 120. The management entity 110 may also update the state of the managed service instance according to the new attributes after the service has been reconfigured.

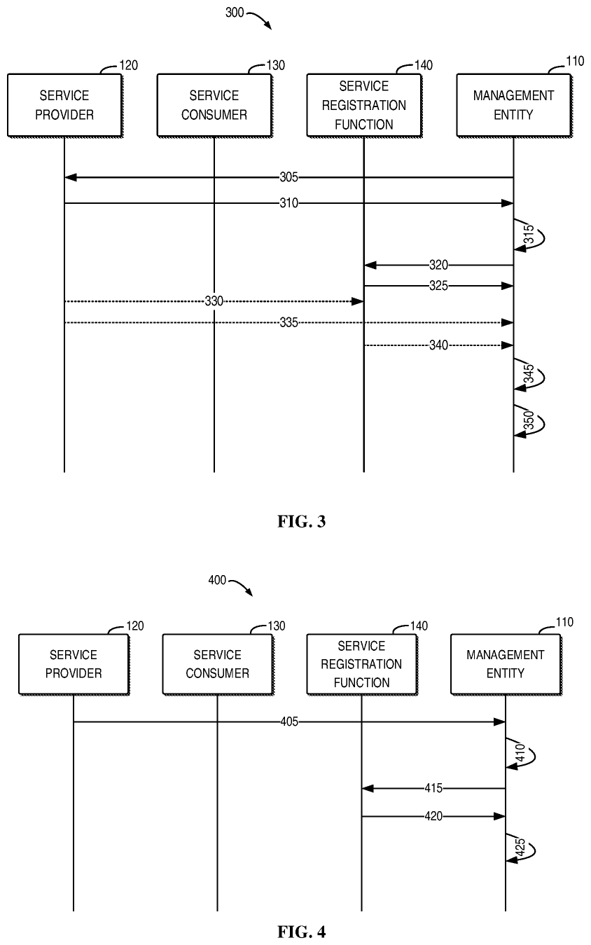

In some embodiments, if the management entity receives a fault notification or performance date, the management entity 110 may update, lock or unlock the service based on the status data. Alternatively, the management entity 110 may control the lifecycle of the service. The process of the service termination and deregistering will be further described later with reference to FIG. 3. Correspondingly, the management entity 110 may further update 280 the state of the managed service instance and synchronize the service status to Service registration function with 285 based on the state of the managed service instance. The action 285 can be existing attribute provisioning service defined already in 3GPP SA5 if the Service Registration Function is in the same management domain of the Service Provider, or the action 285 could be a new defined interface for registration updating request.

FIG. 3 further shows an example process 300 according to example embodiments of the present disclosure. For the purpose of discussion, the process 300 will be described with reference to FIG. 1. The process 300 may, in particular, involve a process of the service termination and deregistering.

If the service is not used by any service consumer, the management entity 110 may perform the process of the service termination. The management entity 110 may determine whether the service is used by the service consumer from the status data of the service received from the service provide.

As shown in FIG. 3, the management entity 110 may transmit a service terminating indication to the service provider 120. If the management entity 110 receives 310 a service terminating message indicating that the service has been terminated, the management entity 110 may update 315 the state of the managed service instance to “Locked/Disabled/Idle” (Administrative State/Operational State/Usage State).

Similar with the process of the registering process, the service provider 120 could initiate the deregistering process. Alternatively, the management entity 110 may also initiate the deregistering process.

In a case that the deregistering process is initiated by the service provider 120, the service provider 120 may transmit 330 the deregistering request to a service registration function 140, at which the service could be registered, discovered or deregistered. After the service is successfully deregistered, as an option, the service provider 120 may inform 335 the management entity 110 that the service has been deregistered. As another option, the service registration function 140 may inform 340 the management entity 110 that the service has been deregistered. The action 340 can be existing attribute change notification defined already in 3GPP SA5 if the Service Registration Function is in the same management domain of the Service Provider, or the action 340 could be a new defined interface for deregistering notification. After the management entity 110 receives a message indicating that the service has been deregistered, the management entity 110 may update 345 the deregistering state of the managed service instance. That is, the state of the deregistering is changed from “Registered” to “Deregistered”.

In a case that the process of the deregistering is initiated by the management entity 110, the management entity 110 may transmit 320 the deregistering request to a service registration function 140. The action 320 can be existing attribute provisioning service defined already in 3GPP SA5 if the Service Registration Function is in the same management domain of the Service Provider, or the action 320 could be a new defined interface for deregistering request. If the management entity 110 receives 325 a message indicating that the service has been deregistered, the management entity 110 may update 345 the registering state of the managed service instance. The registering state is changed from “Registered” to “Deregistered”.

As an option, after the service has been registered, the management entity 110 may delete 350 the managed service instance associated with the registered service, if the service will not be used anymore.

In some embodiment, the service may be deregistered even if the service is using by some service consumer. For example, if the service has no enough capacity for more service consumers which intend to access the service. In this case, the management entity 110 may deregistered the service. Meanwhile, the service is also provided to the service consumer which has already accessed to the service.

In some embodiment, the service may be deregistered when the service is locked, rather than terminated. If the state of service is changed from locked to unlocked, the service will be registered again by the management entity 110.

In some embodiment, the management entity 110 may detect that the service does not work based on the received status data. An extreme case is that some accident event, such as power down, may occur at the service provider. In this case, the service provider may neither transmit a fault notification to the management entity 110 to inform the event nor transmit a deregistering request to the Service Registration Function before the service provider does not work. In other words, the management entity 110 may detect that the service is unavailable. In this case, the managed service instance will be set to disabled by the management entity 110.

FIG. 4 shows a diagram of an example process 400 of service based architecture management according to some example embodiments of the present disclosure. For the purpose of discussion, the process 400 will be described with reference to FIG. 1. The process 400 may, in particular, involve a disabling process of the service.

As shown in FIG. 4, the management entity 110 receives 405 the status data of the service from the service provider 120. If the management entity 110 determines that the service does not work, the management entity 110 may update 410 the state of the managed service instance. That is, the state of the managed service instance may be set to “Disabled” (Operational State). Optionally, the administration and usage state may also be updated.

Then the management entity 110 may further deregister the service. The actions 415-425 as shown in FIG. 4 may equal to the actions 320, 325 and 345, which will not be described herein.

In this way, a service based architecture management is allowed to manage the lifecycle, performance, alarm, state at service level, and share resources between network slices in service level, as well as assist registration of a service to the service registration function. This mechanism is expected to be reused by other standardization organization for service based architecture management.

The service based architecture management mechanism of the present disclosure introduces abstract Service Information Object Class (IOC) in a Federated Network Information Model (FNIM). The Service_ IOC is inherited from Top_. The Service_ IOC may also be contained in Domain_, ManagedElement_, ManagedFunction_, ManagementSystem_ or other relevant UIM IOCs.

The service based architecture management mechanism of the present disclosure also introduces Managed Service for NF Service as root object in 3GPP NRM. The Managed Service IOC is inherited from UIM Service_ IOC. The Managed Service IOC can be contained in Subnetwork, ManagedElement, ManagedFunction, or other relevant Generic IOCs.

The service based architecture management mechanism of the present disclosure is introduced to support Registration management for NF Service. In this management mechanism, the registration state is defined in a Managed Service IOC for the NF Service. The new interface between Management Function and Service Registration Function is defined to interact with Service Registration Function (e.g. NRF of 3GPP) to register, deregister or update a NF Service and interact with Service Registration Function, Network Function to sync the registration state of a NF Service, as well as detect and report the inconsistence between Service Registration Function, Network Function and Management Function.

The service based architecture management mechanism of the present disclosure is introduced to support State Management for a NF Service. The administrative state, operational state, usage state, available status is defined in a Managed Service IOC for the NF Service. The state change of the NF Service could be monitored by Management Function. The State Management for a NF Service is supported to interact with Network Function to update the state of the NF Service.

The service based architecture management mechanism of the present disclosure is introduced to support Lifecycle Management (LCM), Configuration Management (CM), Performance Management (PM) and Fault Management (FM) of a NF Service, including define resource and configuration related attributes in in a Managed Service IOC for the NF Service; associate performance and fault management IOCs to the Managed Service IOC for the NF Service; support lifecycle management of a NF Service; support configuration of a NF Service; support performance control and collection of a NF Service; and support fault supervision of a NF Service.

In some embodiments, the service registration function 140 shown in FIG. 2 may be considered as a service provider, which may provide register, deregister, subscribe, notification, discovery, etc., services to RegistrationServiceConsumer to register or discover a service. For example, NRF is ServiceRegistrationFunction in 5G Core system.

Corresponding to the service consumer, a registering service consumer is deployed to consume a service of ServiceRegistrationFunction for service registration, deregistration, subscription, notification, discovery, etc. For Example, most 5G Core Control network functions are RegistrationServiceConsumer and the 3GPP SA5 defined Management Function is also RegistrationServiceConsumer.

In this case, the management entity 110 shown in FIG. 2 may interact with ServiceRegistrationFunction to manage lifecycle, configuration, performance, alarm, state of a registering related service. For example, it can be Management Function defined in 3GPP SA5.

FIG. 5 shows a diagram of an example process 500 of service based architecture/network management according to some example embodiments of the present disclosure. For the purpose of discussion, the process 500 will be described with reference to FIG. 1. The process 400 may, in particular, involve the Registration Service

As shown in FIG. 5, the management entity 110 creates 505 a managed service instance for a registration service at the service registration function 140.

If the managed service instance is creating, some attributes of the service are defined for the managed service instance by the management entity 110. The attributes associated with the service may include the state of the managed service instance. The state of the managed service instance may include an operational state, a usage state, and an administrative state. Besides the state, the attributes associated with the service may further include an attribute associated with lifecycle management; an attribute associated with configuration management; an attribute associated with performance management; an attribute associated with fault management; an attribute associated with trace management; an attribute associated with software management; an attribute associated with account management; and an attribute associated with security management.

In the phase of service deployment, the state of the managed service instance is “Locked/Disabled/Idle” (Administrative State/Operational State/Usage State). The deployment and configuration related attributes of the service are stored in managed service instance. A performance management instance is created and associated to the managed service instance. A fault management instance is created and associated to the managed service instance.

The management entity 110 transmits 510 the set of attributes to the service registration function 140. The attributes, in particular the administrative state defined the managed service instance may cause the service to be unlocked. Thus, the management entity 110 may deploy, configure and unlock the service based on deployment and configuration related attributes passed from the management entity 110.

Further, the management entity 110 receives 515 service activating message from the service registration function 140. The service activating message may indicate that the service is activated. After receiving the response from the service registration function 140, the management entity 110 updates 525 the state of the managed service instance based on the service activating message.

In some embodiments, if the service has been activated, the state of the managed service instance may be set as “Unlocked/Enabled/Idle” (Administrative State/Operational State/Usage State).

The registration service consumer 501 may access 530 the service registration function 140 for the registering service. If the service is accessed by the registering service consumer 501, the service registration function 140 may transmit 535 the report of the the usage status to the management entity 110.

In some embodiments, the usage status of the service can be part of performance data which can be initiated to send by the service registration function 140 or requested by the management entity 110.

If the service is accessed by the registering service consumer 501 and a message is received from the service provider 120 indicating that the service has been accessed, the management entity 110 may update 540 the state of the managed service instance, again.

The management entity 110 may configure performance control parameters on the service registration function 140 based on the performance management instance associated to the managed service instance and collects performance data of the service according to performance control parameters.

The management entity 110 may configure fault control parameters on the service registration function 140 based on the fault management instance associated to the managed service instance and collects alarm/event of the service of the service according to fault control parameters.

Similar with the service provider 120 as shown in FIG. 2, it should be understood that service registration function 140 may inform the performance data or alarm/event of the service to the management entity 110. Alternatively, the management entity 110 may request the performance data or alarm/event of the service from the service registration function 140.

If the service has been deployed, the service registration function 140 may transmit 545 the status data, such as the performance data or alarm/event of the service, to the management entity 110. After analyzed the status data, if the performance of service is getting worse or the alarm is notified, the management entity 110 may perform the attribute reconfiguration to optimize the performance of service.

For example, the management entity 110 may transmit 550 a set of new attributes to the service registration function 140. The management entity 110 may also update the state of the managed service instance according to the new attributes after the service has been reconfigured.

In some embodiments, if the management entity receives a fault notification or performance date, the management entity 110 may update, terminate, lock or unlock the service based on the status data. Alternatively, the management entity 110 may control the lifecycle of the service. Correspondingly, the management entity 110 may further update 555 the state of the managed service instance.

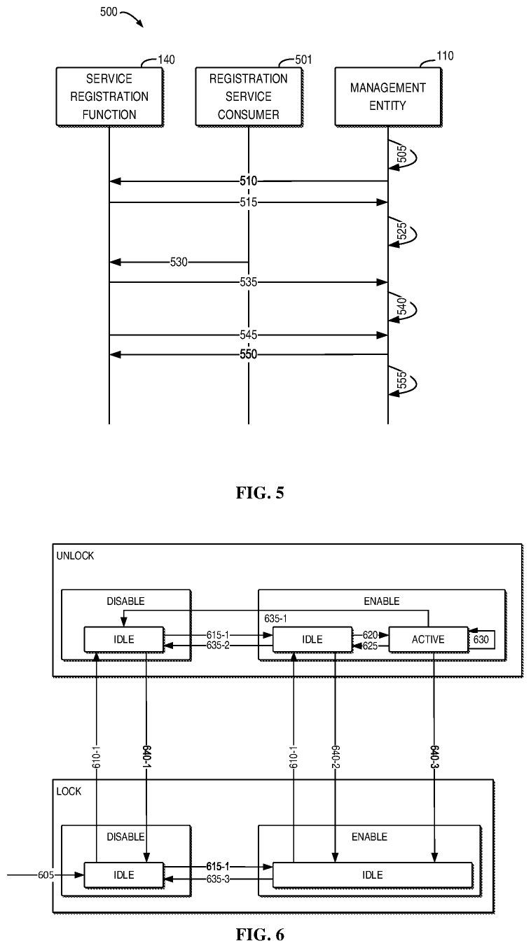

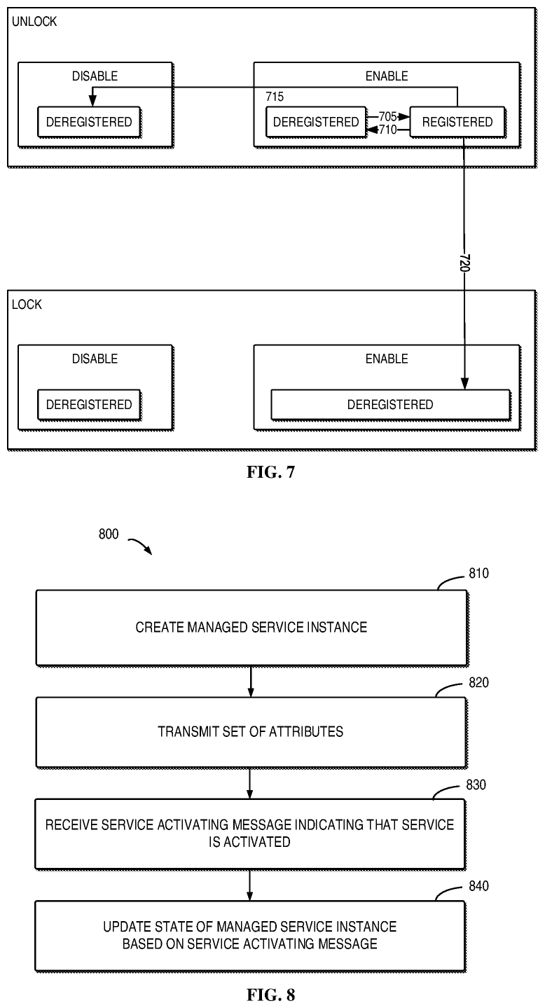

FIGS. 6-7 show examples of state machine of the managed service instance according to example embodiments of the present disclosure.

As shown in FIG. 6, the state change of the managed service instance in the process 200 may be listed as below:
A managed service instance is created (arrow 605).
A service is unlocked, the Administrative State of the service will change from Locked to Unlocked and the Operational and Usage States keep no change (arrows 610-1, 610-2).
A service was enabled once the service was deployed and configured. The operational State of the service will change from Disabled to Enabled, Administrative and Usage States keep no change (arrows 615-1, 615-2).
When the Administrative State is Unlocked and Operational State is Enabled, the first user uses the service, Usage State of the service will change from Idle to Active, and Administrative and Operational States keep no change (arrow 620).
When the Administrative State is Unlocked and Operational State is Enabled, the last user quits the service, Usage State of the service will change from Active to Idle, Administrative and Operational States keep no change (arrow 625).
When the Administrative State is Unlocked and Operational State is Enabled, a new user uses the service or old user quits the service, Usage State, Administrative and Operational States keep no change (arrow 630).
A service was disabled once the resource of the service was withdrawn, e.g. the service was terminated, the Operational State of the service will change from Enable to Disabled, Usage State of the service will change to Idle and Administrative keeps no change (arrows 635-1, 635-2, 635-3).
A service is locked. Administrative State of the service will change from Unlocked to Locked. The Usage State of the service will change to Idle. The Operational state keeps no change (arrows 640-1, 640-2, 640-3).

As shown in FIG. 7, the state change of the managed service instance in the process 200 may be listed as below:
A Management Function (MnF) could call NRF to register a NF service as a service producer, or the Management Function could be notified by either NRF or NF which supporting the NF service once the service is self-registered, and the MnF changes the registration state of the related Managed Service Object to “Registered” (arrow 705).
A Management Function could call NRF to deregister a NF service, or the Management Function could be notified by either NRF or NF which supporting the NF service once the service is self-deregistered, and the MnF changes the registering state of the related Managed Service Object to “Deregistered” (arrow 710).
If a NF service is disabled, the Management Function could call NRF to deregister the NF service, and changes the registering state of the related Managed Service Object to “Deregistered”. Alternatively, the Management Function could call NRF to update the state of the registered NF service to Disabled. Alternatively, the NF which supporting the NF service could interact with NRF to deregister the NF service or update the state of the NF service. This last option is out the scope of SA5 (arrow 715).
If a NF service is locked, the Management Function could call NRF to deregister the NF service, and changes the registering state of the related Managed Service Object to “Deregistered”. Alternatively, the Management Function could call NRF to update the state of the registered NF service to Locked. Alternatively, the NF which supporting the NF service could interact with NRF to deregister the NF service or update the state of the NF service. This last option is out the scope of SA5 (arrow 720).
Next, the Management Function of a Managed Service could call NRF to update the registered NF service to sync with status of the NF, and detect and report the inconsistence between NRF, NF and Managed Service Object in the Management Function.

In this way, a state machine for the managed service is introduced for updating the state of the managed service instance based on the service status, to allow management system to manage the lifecycle, performance, alarm, state at service level, and share resources between network slices in service level, as well as assist registration of a service to the Service Registration Function.

FIG. 8 shows a flowchart of an example method 800 for a service based architecture management according to some example embodiments of the present disclosure. The method 800 can be implemented at the management entity 110 as shown in FIGS. 1-5. For the purpose of discussion, the method 800 will be described with reference to FIGS. 1-5.

At 810, the management entity 110 creates a managed service instance for managing a service associated with a service provider, the managed service instance including a set of attributes associated with the service at least including a state of the managed service instance.

In some embodiments, if the service is requested by a user, the management entity 110 may create the managed service instance.

In some embodiments, the management entity 110 may transmit a service deployment request to at least one of the service provider and a further management entity, to enable the service provider to deploy the service based on the managed service instance.

In some embodiments, if the service is already deployed, the management entity 110 may create the managed service instance.

At 820, the management entity 110 transmits the set of attributes to the service provider, to enable the service provider to activate the service based on the set of attributes.

In some embodiments, the set of attributes further comprises at least one of the following: an attribute associated with state management; an attribute associated with registration management; an attribute associated with lifecycle management; an attribute associated with configuration management; an attribute associated with performance management; and an attribute associated with fault management; an attribute associated with trace management; an attribute associated with software management; an attribute associated with account management; and an attribute associated with security management.

At 830, the management entity 110 receives, from the service provider, a service activating message indicating that the service is activated.

At 840, the management entity 110 updates the state of the managed service instance based on the service activating message.

In some embodiments, the management entity 110 may further receive, from the service provider, the service registering message indicating that the service has been registered by the service provider at a service registration function, the service registration function being used for registering the service, discovering the service or deregistering the service; and update a registration state of the managed service instance based on the service registering message.

In some embodiments, the management entity 110 may further receive, from a service registration function, the service registering message indicating that the service has been registered by the service provider at a service registration function, the service registration function being used for registering the service, discovering the service or deregistering the service; and update a registering state of the managed service instance based on the service registering message.

In some embodiments, if the management entity 110 receives from the service provider, the service activating message indicating the service is activated, the management entity 110 may transmit, to a service registration function, a service registering request to enable the service to be registered. The management entity 110 may further receive, from the service registration function, the service registering message indicating that the service has been registered and update a registering state of the managed service instance based on the service registering message.

In some embodiments, if the management entity 110 receives from the service provider, the service usage message indicating that the service is accessed by the service consumer, the management entity 110 may update the state of the managed service instance based on the service usage message.

In some embodiments, the management entity 110 may obtain, from the service provider, status data of the service during the service being accessed by the service consumer and perform a service change based on the status data, the service change including at least one of the following: locking the service; unlocking the service; scaling the service; updating the service; and terminating the service.

In some embodiments, the management entity 110 may transmit, to a service registration function, a service change message indicating the service has been changed, if the management entity 110 detects that the service change has been performed.

In some embodiments, the management entity 110 may obtain performance parameters of the service or a fault notification of the service; a notification of attributes change; and a notification of a lifecycle change.

In some embodiments, the management entity 110 may transmit, based on the status data, a service terminating indication to the service provider and if the management entity 110 receives, from the service provider, a service terminating message indicating that the service has been terminated, the management entity 110 may update the state of the managed service instance based on the service terminating message.

In some embodiments, the management entity 110 may receive, from the service provider, the service deregistering message indicating that the service has been deregistered by the service provider at a service registration function; and update a registering state of the managed service instance based on the service deregistering message.

In some embodiments, the management entity 110 may receive, from the service registration function, the service deregistering message indicating that the service has been deregistered by the service provider at a service registration function; and update a registering state of the managed service instance based on the service deregistering message.

In some embodiments, the management entity 110 may disable the managed service instance, if the management entity 110 detects the service is unavailable.

In some embodiments, the management entity 110 may transmit, to a service registration function, a deregistering request to enable the service to be deregistered; receive, from the service registration function, the service deregistering message indicating that the service has been deregistered and update a registering state of the managed service instance base on the service deregistering message.

In some example embodiments, an apparatus capable of performing the method 800 (for example, implemented at the management entity 110) may comprise means for performing the respective steps of the method 800. The means may be implemented in any suitable form. For example, the means may be implemented in a circuitry or software module.

In some example embodiments, the apparatus capable of performing the method 800 comprise means for creating, at a management entity, a managed service instance for managing a service associated with a service provider, the managed service instance including a set of attributes associated with the service at least including a state of the managed service instance; means for transmitting the set of attributes to the service provider, to enable the service provider to activate the service based on the set of attributes; means for receiving, from the service provider, a service activating message indicating that the service is activated; and means for updating the state of the managed service instance based on the service activating message.

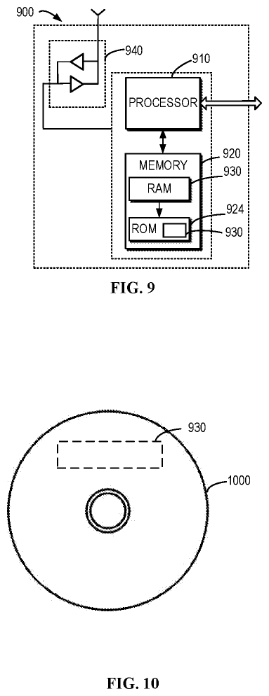

FIG. 9 is a simplified block diagram of a device 900 that is suitable for implementing embodiments of the present disclosure. The device 900 may be provided to implement the management entity 110 as shown in FIG. 1. As shown, the device 900 includes one or more processors 910, one or more memories 920 coupled to the processor 910, and one or more transmitters and/or receivers (TX/RX) 940 coupled to the processor 910.

The TX/RX 940 is for bidirectional communications. The TX/RX 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 924. The processor 910 may perform any suitable actions and processing by loading the program 930 into the RAM 922.

The embodiments of the present disclosure may be implemented by means of the program 930 so that the device 900 may perform any process of the disclosure as discussed with reference to FIGS. 2 to 8. The embodiments of the present disclosure may also be implemented by hardware or by a combination of software and hardware.

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. For example, in some embodiments, various examples of the present disclosure (e.g., a method, apparatus or device) may be partly or fully implemented on the computer readable medium. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The units included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

As examples, embodiments of the present disclosure may be described in the context of the computer-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, a computer readable medium may be any tangible medium that may contain, or store a program for use by or in connection with an instruction execution system, apparatus, or device. The computer readable medium may be a machine readable signal medium or a machine readable storage medium. The computer readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain cases, multitasking and parallel processing may be advantageous.

Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it would be appreciated that the present disclosure defined in the appended claims is not necessarily limited to the specific features or acts described above. Rather, the specific features and acts described above are disclosed as example forms of implementing the claims.

1. A method, comprising:
creating, at a management entity, a managed service instance for managing a service associated with a service provider, the managed service instance including a set of attributes associated with the service at least including a state of the managed service instance;
transmitting the set of attributes to the service provider, to enable the service provider to activate the service based on the set of attributes;
receiving, from the service provider, a service activating message indicating that the service is activated; and
updating the state of the managed service instance based on the service activating message.

2. The method of claim 1, wherein creating the managed service instance comprises at least one of the following:
in response to the service being requested by a user, creating the managed service instance; and
in response to the service being already deployed, creating the managed service instance.

3. The method of claim 1, further comprising:
receiving, a service registering message indicating that the service has been registered at a service registration function from one of the service provider and the service registration function; and
updating a registration state of the managed service instance based on the service registering message.

4. The method of claim 1, further comprising:
in response to receiving, from the service provider, the service activating message indicating the service is activated, transmitting, to a service registration function, a service registering request to enable the service to be registered;
receiving, from the service registration function, a service registering message indicating that the service has been registered; and
updating a registration state of the managed service instance based on the service registering message.

5. The method of claim 1, further comprising:
obtaining, from the service provider, status data of the service during the service being provided;
performing a service change based on the status data, the service change including at least one of the following:
locking the service;
unlocking the service;
scaling the service;
updating the service; and
terminating the service; and
in response to detecting that the service change has been performed, transmitting, to a service registration function, a service change message indicating the service has been changed.

6. The method of claim 1, further comprising:
transmitting a service terminating indication to the service provider; and
in response to receiving, from the service provider, a service terminating message indicating that the service has been terminated, updating the state of the managed service instance based on the service terminating message.

7. The method of claim 6, further comprising:
receiving a service deregistering message indicating that the service has been deregistered at a service registration function from one of the service provider and the service registration function; and
updating a registration state of the managed service instance based on the service deregistering message.

8. The method of claim 1, further comprising:
in response to detecting the service being unavailable, updating the state of the managed service instance.

9. The method of claim 6, further comprising:
transmitting, to a service registration function, a deregistering request to allow the service to be deregistered;
receiving, from the service registration function, a service deregistering message indicating that the service has been deregistered; and
updating a registration state of the managed service instance based on the service deregistering message.

10. A device, comprising:
at least one processor; and
at least one memory including computer program codes;
the at least one memory and the computer program codes are configured to, with the at least one processor, cause the device at least to:
create, at a management entity, a managed service instance for managing a service associated with a service provider, the managed service instance including a set of attributes associated with the service at least including a state of the managed service instance;
transmit the set of attributes to the service provider, to enable the service provider to activate the service based on the set of attributes received, from the service provider, a service activating message indicating that the service is activated; and
update the state of the managed service instance based on the service activating message.

11. The device of claim 10, wherein the device is caused to create the managed service instance by at least one of the following:
in response to the service being requested by a user, creating the managed service instance; and
in response to the service being already deployed, creating the managed service instance.

12. The device of claim 10, wherein the device is further caused to:
receive a service registering message indicating that the service has been registered at a service registration function from one of the service provider and the service registration function; and
update a registering state of the managed service instance based on the service registering message.

13. The device of claim 10, wherein the device is further caused to:
in response to receiving, from the service provider, the service activating message indicating the service is activated, transmit, to a service registration function, a service registering request to enable the service to be registered;
receive, from the service registration function, a service registering message indicating that the service has been registered; and
update a registering state of the managed service instance based on the service registering message.

14. The device of claim 10, wherein the device is further caused to:
obtain, from the service provider, status data of the service during the service being accessed by a service consumer;
perform a service change based on the status data, the service change including at least one of the following:
locking the service;
unlocking the service;
scaling the service;
updating the service; and
terminating the service; and
in response to detecting that the service change has been performed, transmit, to a service registration function, a service change message indicating the service has been changed.

15. The device of claim 10, wherein the device is further caused to:
transmit a service terminating indication to the service provider; and
in response to receiving, from the service provider, a service terminating message indicating that the service has been terminated, update the state of the managed service instance based on the service terminating message.

16. The device of claim 15, wherein the device is further caused to:
receive a service deregistering message indicating that the service has been deregistered at a service registration function from one of the service provider and the service registration function; and
update a registering state of the managed service instance based on the service deregistering message.

17. The device of claim 10, wherein the device is further caused to:
in response to detecting the service being unavailable, update the state of the managed service instance.

18. The device of claim 15, wherein the device is further caused to:
transmit, to a service registration function, a deregistering request to allow the service to be deregistered, the service registration function being used for registering the service, discovering the service or deregistering the service;
receive, from the service registration function, a service deregistering message indicating the service being deregistered; and
update a registering state of the managed service instance based on a service status message.

19. An apparatus, comprising:
means for creating, at a management entity, a managed service instance for managing a service associated with a service provider, the managed service instance including a set of attributes associated with the service at least including a state of the managed service instance;
means for transmitting the set of attributes to the service provider, to enable the service provider to activate the service based on the set of attributes;
means for receiving, from the service provider, a service activating message indicating that the service is activated; and
means for updating the state of the managed service instance based on the service activating message.

20. A non-transitory computer readable medium comprising program instructions for causing an apparatus to perform at least the method of claim 1.
